(19) United States
(12) Patent Application Publication
(10) Pub. No.: US 2024/0312145 A1
(43) Pub. Date: Sep. 19, 2024

(54) TIGHT IMU-CAMERA COUPLING FOR DYNAMIC BENDING ESTIMATION

(71) Applicant: Snap Inc., Santa Monica, CA (US)

(72) Inventors: Jeroen Diederik Hol, Hengelo (NL); Matthias Kalkgruber, Vienna (AT); Tiago Miguel Pereira Torres, Vienna (AT)

(21) Appl. No.: 18/184,333

(22) Filed: Mar. 15, 2023

(51) Int. Cl. G06T 19/00; G01C 21/16; G02B 27/01; G06V 10/74

(52) U.S. Cl. CPC G06T 19/006; G01C 21/1652; G01C 21/1656; G02B 27/0172; G06V 10/761; G02B 2027/0178

(57) ABSTRACT

A method for correcting bending of a flexible display device is described. The method includes forming a plurality of sensor groups of an augmented reality (AR) display device, where one of the plurality of sensor groups includes a combination of a camera, an IMU (inertial measurement unit), and a component, each being tightly coupled to each other, a spatial relationship between the camera, the IMU sensor, or the component being predefined, accessing sensor groups data from the plurality of sensor groups, estimating a spatial relationship between the plurality of sensor groups based on the sensor groups data, and displaying virtual content in a display of the AR display device based on the spatial relationship between the plurality of sensor groups.

### TECHNICAL FIELD

The subject matter disclosed herein generally relates to a visual tracking system. Specifically, the present disclosure addresses systems and methods for mitigating bending effects in visual-inertial tracking systems.

### BACKGROUND

An augmented reality (AR) device enables a user to observe a scene while simultaneously seeing relevant virtual content that may be aligned to items, images, objects, or environments in the field of view of the device. A virtual reality (VR) device provides a more immersive experience than an AR device. The VR device blocks out the field of view of the user with virtual content that is displayed based on the position and orientation of the VR device.

Both AR and VR devices rely on motion tracking systems that track a pose (e.g., orientation, position, location) of the device. The motion tracking system is typically factory calibrated (based on predefined relative positions between the cameras and other sensors) to accurately display the virtual content at a desired location relative to its environment. However, factory calibration parameters can drift over time as the user wears the AR/VR device due to mechanical stress (e.g., bending of an eyewear frame) in the AR/VR device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an environment for operating a display device in accordance with one example embodiment.

FIG. 2 is a block diagram illustrating a display device in accordance with one example embodiment.

FIG. 3 is a block diagram illustrating a visual tracking system in accordance with one example embodiment.

FIG. 4 is a block diagram illustrating a dynamic bending estimation module in accordance with one example embodiment.

FIG. 5 is a block diagram illustrating a corrected frame in accordance with one example embodiment.

FIG. 6 illustrates rigid and non-rigid component coupling in accordance with one example embodiment.

FIG. 7 illustrates an example trajectory of a display device in accordance with one example embodiment.

FIG. 8 is a flow diagram illustrating a method for adjusting a frame in accordance with one example embodiment.

FIG. 9 is a flow diagram illustrating a method for processing a frame in accordance with one example embodiment.

FIG. 10 is a flow diagram illustrating a method for detecting spatial changes based on a proximity sensor in accordance with one example embodiment.

FIG. 11 illustrates a network environment in which a head-wearable device can be implemented according to one example embodiment.

FIG. 12 is block diagram showing a software architecture within which the present disclosure may be implemented, according to an example embodiment.

FIG. 13 is a diagrammatic representation of a machine in the form of a computer system within which a set of instructions may be executed for causing the machine to perform any one or more of the methodologies discussed herein, according to one example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The term “augmented reality” (AR) is used herein to refer to an interactive experience of a real-world environment where physical objects that reside in the real-world are “augmented” or enhanced by computer-generated digital content (also referred to as virtual content or synthetic content). AR can also refer to a system that enables a combination of real and virtual worlds, real-time interaction, and 3D registration of virtual and real objects. A user of an AR system perceives virtual content that appears to be attached or interact with a real-world physical object.

The term “virtual reality” (VR) is used herein to refer to a simulation experience of a virtual world environment that is completely distinct from the real-world environment. Computer-generated digital content is displayed in the virtual world environment. VR also refers to a system that enables a user of a VR system to be completely immersed in the virtual world environment and to interact with virtual objects presented in the virtual world environment.

The term “AR application” is used herein to refer to a computer-operated application that enables an AR experience. The term “VR application” is used herein to refer to a computer-operated application that enables a VR experience. The term “AR/VR application” refers to a computer-operated application that enables a combination of an AR experience or a VR experience.

The term “visual tracking system” is used herein to refer to a computer-operated application or system that enables a system to track visual features identified in images captured by one or more cameras of the visual tracking system. The visual tracking system builds a model of a real-world environment based on the tracked visual features. Non-limiting examples of the visual tracking system include: a visual Simultaneous Localization and Mapping system (VSLAM), and Visual Inertial Odometry (VIO) system. VSLAM can be used to build a target from an environment, or a scene based on one or more cameras of the visual tracking system. VIO (also referred to as a visual-inertial tracking system) determines a latest pose (e.g., position and orientation) of a device based on data acquired from multiple sensors (e.g., optical sensors, inertial sensors) of the device.

The term “Inertial Measurement Unit” (IMU) is used herein to refer to a device that can report on the inertial status of a moving body including the acceleration, velocity, orientation, and position of the moving body. An IMU enables tracking of movement of a body by integrating the acceleration and the angular velocity measured by the IMU. IMU can also refer to a combination of accelerometers and gyroscopes that can determine and quantify linear acceleration and angular velocity, respectively. The values obtained from the IMUs gyroscopes can be processed to obtain the pitch, roll, and heading of the IMU and, therefore, of the body with which the IMU is associated. Signals from the IMU's accelerometers also can be processed to obtain velocity and displacement of the IMU.

The term “flexible device” is used herein to refer to a device that is capable of bending without breaking. Non-limiting examples of flexible devices include: head-worn devices such as glasses, flexible display devices such as AR/VR glasses, or any other wearable devices that are capable of bending without breaking to fit a body part of the user.

Both AR and VR applications allow a user to access information, such as in the form of virtual content rendered in a display of an AR/VR display device (also referred to as a display device, flexible device, flexible display device). The rendering of the virtual content may be based on a position of the display device relative to a physical object or relative to a frame of reference (external to the display device) so that the virtual content correctly appears in the display. For AR, the virtual content appears aligned with a physical object as perceived by the user and a camera of the AR display device. The virtual content appears to be attached to the physical world (e.g., a physical object of interest). To do this, the AR display device detects the physical object and tracks a pose of the AR display device relative to the position of the physical object. A pose identifies a position and orientation of the display device relative to a frame of reference or relative to another object. For VR, the virtual object appears at a location based on the pose of the VR display device. The virtual content is therefore refreshed based on the latest pose of the device. A visual tracking system at the display device determines the pose of the display device.

Flexible devices that include a visual tracking system can operate with one or more cameras that are mounted on the flexible device. For example, one camera is mounted to a left temple of a frame of the flexible device, and another camera is mounted to the right temple of the frame of the flexible device. The flexible device can bend to accommodate different user head sizes. The flexible device may be designed for more ergonomic and visually appealing frame designs that are less rigid. However, such flexible design also leads to spatial relations between the different components (e.g., such as displays, cameras, IMUs, and projectors) to change over time. Such spatial relations can change during normal operation by simply putting them on, walking or touching the frame. The frame bending and changes in the spatial relations result in undesirable shift (away from factory calibrated configuration) in the stereo images that lead to unrealistic AR experiences (from errors in sensing the environment using the shifted stereo images). Therefore, the exact knowledge of the spatial relations of key system components of the display device is important for an accurate AR experience.

Existing methods to mitigate the frame bending include:
Highly accurate factory calibration per device: this can be time-consuming.
Increasing the rigidity of the glasses resulting in specialized frame structures and bulky uncomfortable designs.
Allowing the device model to use a best fit approach to estimate spatial relations: this results in additional computational requirements.

The present application describes a flexible device where each IMU sensor is rigidly mounted to a corresponding camera in multi-camera devices to measure spatial relations in the display device during runtime. The IMU sensors are used to dynamically measure the spatial relationship changes between each sensing group (e.g., IMU1+camera1 and IMU2+camera2). The IMU data can be used to predict and estimate frame bending before camera frames are processed. Because each camera is rigidly connected to its own IMU, the flexible device does not need to estimate the spatial change between each camera and corresponding IMU (thereby removing uncertainty from the internal IMU state estimation). Having rigidly connected IMU sensors and cameras allow for more flexible and ergonomic frame designs, while maintaining close to optimal AR experiences.

In one example embodiment, a method includes forming a plurality of sensor groups of an augmented reality (AR) display device, where one of the plurality of sensor groups includes a camera being tightly coupled to a corresponding IMU (inertial measurement unit) sensor, a spatial relationship between the camera and the corresponding IMU sensor being predefined, accessing sensor groups data from the plurality of sensor groups, estimating a spatial relationship between the plurality of sensor groups based on the sensor groups data, and displaying virtual content in a display of the AR display device based on the spatial relationship between the plurality of sensor groups.

As a result, one or more of the methodologies described herein facilitate solving the technical problem of inaccurate display of stereo images generated from a bendable device. In other words, the bending of the flexible device causes errors in the spatial relationship between the cameras and the display. The presently described method provides an improvement to an operation of the functioning of a computing device by correctly estimating the spatial relations of components of a flexible device that is bent. As such, one or more of the methodologies described herein may obviate a need for certain efforts or computing resources. Examples of such computing resources include processor cycles, network traffic, memory usage, data storage capacity, power consumption, network bandwidth, and cooling capacity.

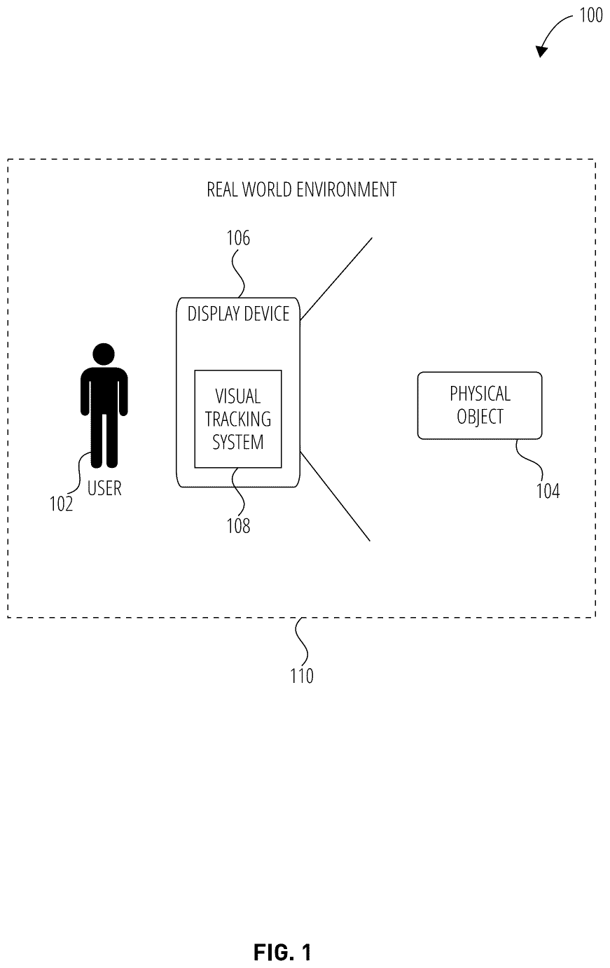

FIG. 1 is a network diagram illustrating an environment 100 suitable for operating a display device 106, according to some example embodiments. The environment 100 includes a user 102, a display device 106, and a physical object 104. A user 102 operates the display device 106. The user 102 may be a human user (e.g., a human being), a machine user (e.g., a computer configured by a software program to interact with the display device 106), or any suitable combination thereof (e.g., a human assisted by a machine or a machine supervised by a human). The user 102 is associated with the display device 106.

The display device 106 includes a flexible device. In one example, the flexible device includes a computing device with a display such as an eyewear. In one example, the display includes a screen that displays images captured with a camera of the display device 106. In another example, the display of the device may be transparent such as in lenses of wearable computing glasses.

The display device 106 includes an AR application that generates virtual content based on images detected with a camera of the display device 106. For example, the user 102 may point the camera of the display device 106 to capture an image of the physical object 104. The AR application generates virtual content corresponding to an identified object (e.g., physical object 104) in the image and presents the virtual content in a display of the display device 106.

The display device 106 includes a visual tracking system 108. The visual tracking system 108 tracks the pose (e.g., position and orientation) of the display device 106 relative to the real world environment 110 using, for example, optical sensors (e.g., depth-enabled 3D camera, image camera), inertial sensors (e.g., gyroscope, accelerometer, magnetometer), wireless sensors (Bluetooth, Wi-Fi), GPS sensor, and audio sensor. The visual tracking system 108 can include a VIO system. In one example, the display device 106 displays virtual content based on the pose of the display device 106 relative to the real world environment 110 and/or the physical object 104.

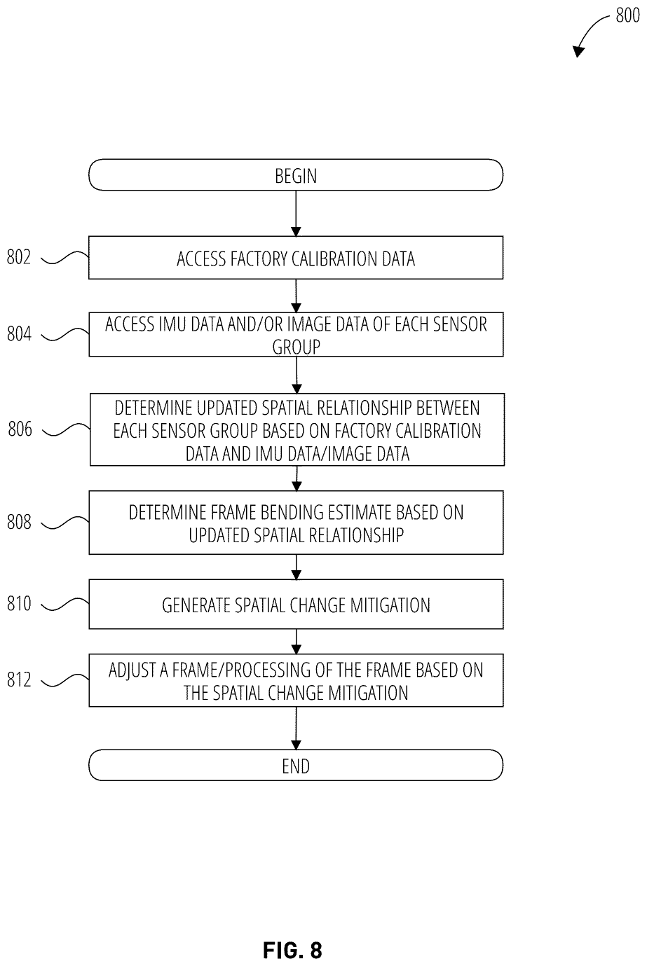

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 8 to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The display device 106 may operate over a computer network. The computer network may be any network that enables communication between or among machines, databases, and devices. Accordingly, the computer network may be a wired network, a wireless network (e.g., a mobile or cellular network), or any suitable combination thereof. The computer network may include one or more portions that constitute a private network, a public network (e.g., the Internet), or any suitable combination thereof.

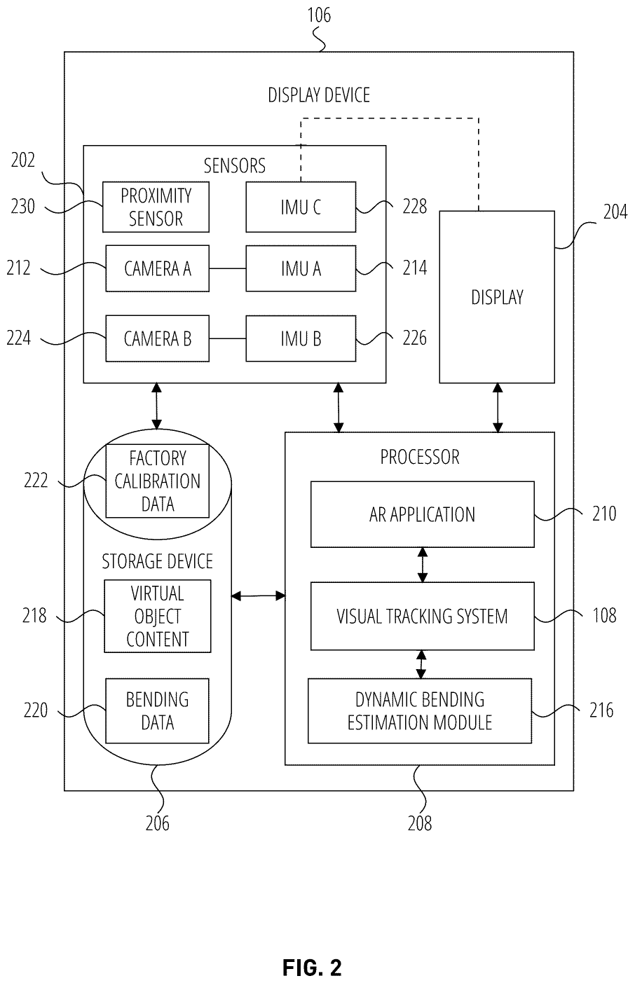

FIG. 2 is a block diagram illustrating modules (e.g., components) of the display device 106, according to some example embodiments. The display device 106 includes sensors 202, a display 204, a processor 208, and a storage device 206. An example of the display device 106 includes a wearable computing device (e.g., smart glasses).

The sensors 202 include, for example, a proximity sensor 230, an IMU C 228, IMU A 214 rigidly connected/mounted to camera A 212, an IMU B 226 rigidly connected/mounted to camera B 224. Because of the rigid connection, the spatial relationship between camera A 212 and IMU A 214 is already predefined and constant. Furthermore, mounting each IMU to a corresponding camera allows for more precise and accurate pixel measurement control (e.g., scanline triggering) and precise triggering of pixel acquisition across stereo baselines for accurate stereo matching and depth inference. Examples of cameras include color cameras, thermal cameras, depth sensor cameras, grayscale cameras, global shutter tracking cameras). Each IMU sensor includes a combination of gyroscope, accelerometer, or magnetometer.

Additional standalone IMUs can be placed in places where deformation is also to be estimated with a lower precision. For example, IMU C 228 can be rigidly connected to another component (e.g., display 204). The information regarding the deformation is further used to estimate the spatial relations of other components. The accurate tracking of spatial relations between different components enables the display device 106 to maintain an optimal user experience.

The proximity sensor 230 is configured to detect whether the display device 106 is being worn. Other examples of sensors 202 include a location sensor (e.g., near field communication, GPS, Bluetooth, Wi-Fi), an audio sensor (e.g., a microphone), or any suitable combination thereof. It is noted that the sensors 202 described herein are for illustration purposes and the sensors 202 are thus not limited to the ones described above.

The display 204 includes a screen or monitor configured to display images generated by the processor 208. In one example embodiment, the display 204 may be translucent so that the user 102 can see through the display 204 (in AR use case). In another example embodiment, the display 204 covers the eyes of the user 102 and blocks out the entire field of view of the user 102 (in VR use case). In another example, the display 204 includes a touchscreen display configured to receive a user input via a contact on the touchscreen display.

The processor 208 includes an AR application 210, a visual tracking system 108, and a dynamic bending estimation module 216. The AR application 210 detects and identifies a physical environment or the physical object 104 using computer vision. The AR application 210 retrieves a virtual object (e.g., 3D object model) based on the identified physical object 104 or physical environment. The AR application 210 renders the virtual object in the display 204. In one example, the AR application 210 includes a local rendering engine that generates a visualization of a virtual object overlaid (e.g., superimposed upon, or otherwise displayed in tandem with) on an image of the physical object 104 captured by the camera A 212 or camera B 224. A visualization of the virtual object may be manipulated by adjusting a position of the physical object 104 (e.g., its physical location, orientation, or both) relative to the camera A 212/camera B 224. Similarly, the visualization of the virtual object may be manipulated by adjusting a pose of the display device 106 relative to the physical object 104.

The visual tracking system 108 estimates a pose of the visual tracking system 108. For example, the visual tracking system 108 uses image data (from camera A 212 and camera B 224) and corresponding inertial data (from IMU A 214 and IMU B 226) to track a location and pose of the display device 106 relative to a frame of reference (e.g., real world environment 110). In one example, the visual tracking system 108 includes a VIO system as previously described above.

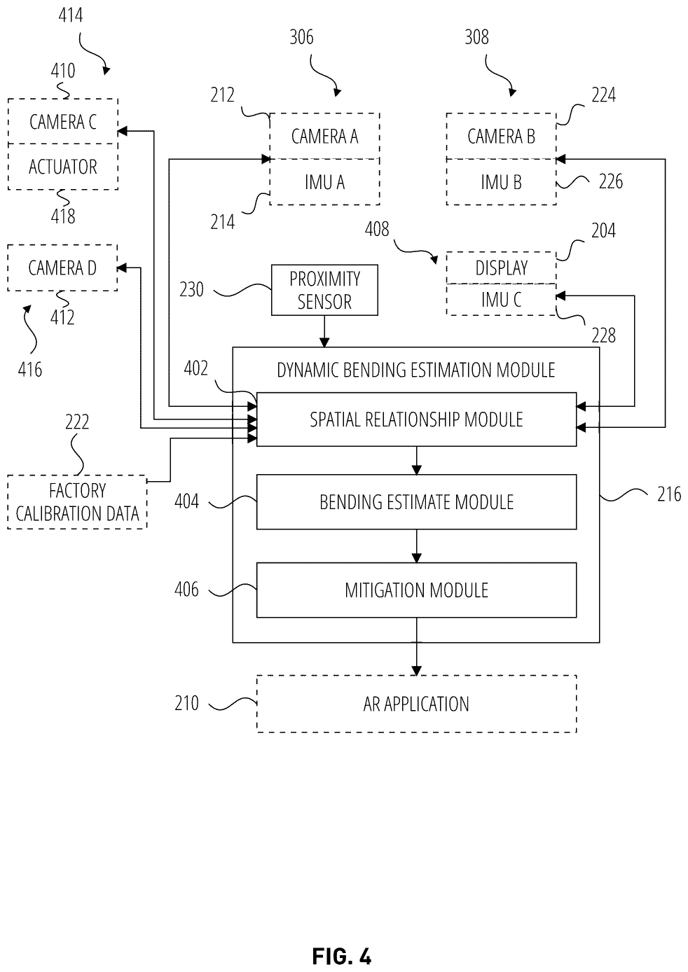

The dynamic bending estimation module 216 accesses IMU data and/or camera data from the visual tracking system 108 to estimate changes in the spatial motion between components (e.g., camera A 212, camera B 224, display 204). Through the IMU data/camera data, the dynamic bending estimation module 216 can predict and estimate frame bending before camera frames from camera A 212 and camera B 224 are processed by the AR application 210 and/or the visual tracking system 108. Examples of bending estimation include pitch, roll, and yaw bending. The dynamic bending estimation module 216 corrects the offsets to mitigate any display errors from the bending. Example components of the dynamic bending estimation module 216 are described in more detail below with respect to FIG. 4.

The storage device 206 stores virtual object content 218, factory calibration data 222, and bending data 220. The factory calibration data 222 include predefined values of spatial relationship between the components (e.g., camera A 212 and camera B 224). The bending data 220 include values of the estimated bending (e.g., pitch-roll bias and yaw bending offsets) of the display device 106. The virtual object content 218 includes, for example, a database of visual references (e.g., images) and corresponding experiences (e.g., three-dimensional virtual objects, interactive features of the three-dimensional virtual objects).

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

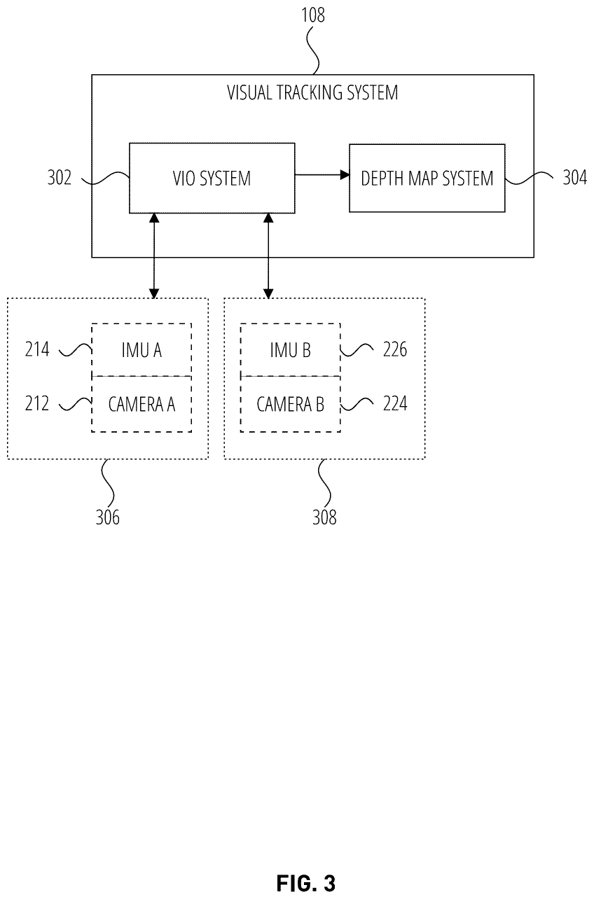

FIG. 3 illustrates the visual tracking system 108 in accordance with one example embodiment. The visual tracking system 108 includes, for example, a VIO system 302 and a depth map system 304. The VIO system 302 accesses inertial sensor data from sensor group 306 (which includes IMU A 214 rigidly/tightly coupled to camera A 212) and sensor group 308 (which includes IMU B 226 rigidly/tightly coupled to camera B 224).

The VIO system 302 determines a pose (e.g., location, position, orientation) of the display device 106 relative to a frame of reference (e.g., real world environment 110). In one example embodiment, the VIO system 302 estimates the pose of the display device 106 based on 3D maps of feature points from images captured with sensor group 306 and sensor group 308.

The depth map system 304 accesses image data from the camera A 212 and generates a depth map based on the VIO data (e.g., feature points depth) from the VIO system 302. For example, the depth map system 304 generates a depth map based on the depth of matched features between a left image (generated by a left side camera) and a right image (generated by a right side camera). In another example, the depth map system 304 is based on triangulation of element disparities in the stereo images.

FIG. 4 is a block diagram illustrating a dynamic bending estimation module 216 in accordance with one example embodiment. The dynamic bending estimation module 216 includes a spatial relationship module 402, a bending estimate module 404, and a mitigation module 406.

The spatial relationship module 402 estimates the spatial relation between sensor groups. A sensor group consists a combination of zero or more IMUs, zero or more cameras, or a combination of the previous coupled to a non-sensor component (e.g., display 204, a projector, or an actuator). For example, a sensor group can include an IMU, a camera, and a component. FIG. 4 illustrates example combinations of sensor groups: sensor group 306 (consisting of camera A 212 rigidly coupled to IMU A 214), sensor group 308 (consisting of camera B 224 rigidly coupled to IMU B 226), sensor group 408 (consisting of display 204 rigidly coupled to IMU C 228), sensor group 414 (consisting of camera C 410 rigidly coupled to actuator 418), sensor group 416 (consisting of camera D 412). The spatial relationship module 402 accesses image data and/or IMU sensor data from the sensor groups. The spatial relationship module 402 retrieves factory calibration data 222 for the sensors from the storage device 206.

The spatial relationship module 402 accesses IMU data (from IMU A 214, IMU B 226, and IMU C 228) and image data (from camera A 212, camera B 224, camera C 410, camera D 412) and estimates spatial relationship between the sensor groups (e.g., sensor group 306, sensor group 308, sensor group 408, camera C 410, camera D 412). The spatial relationship module 402 estimates changes in the relative positions/locations between the IMUs and/or cameras.

In one example, the spatial relationship module 402 accesses image data and IMU data from sensor group 306, sensor group 308 to estimate changes in the relative positions/locations of each sensor group. For example, the spatial relationship module 402 uses the combination of image data and IMU data to detect that sensor group 306 (camera A 212/IMU A 214) has moved closer or further away from sensor group 308 (camera B 224/IMU B 226). The spatial relationship module 402 detects that the sensor group 306 has moved closer or further away from sensor group 308 from an initial spatial location relationship between sensor group 306 and sensor group 308 based on the factory calibration data 222 and sensor data from a combination of camera A 212 and IMU A 214 and a combination of camera B 224 and IMU B 226.

In another example, the spatial relationship module 402 detects that the display 204 is located closer to or further from camera A 212 based on sensor data from sensor group 306 and sensor data from sensor group 408. The sensor data from sensor group 306 includes image data from camera A 212 and/or IMU data from IMU A 214. The sensor data from sensor group 408 includes IMU data from IMU C 228.

In another example, the spatial relationship module 402 detects that the actuator 418 is located closer to or further from camera B 224 based on sensor data from sensor group 308 and sensor data from sensor group 414. The sensor data from sensor group 308 includes image data from camera B 224 and/or IMU data from IMU B 226. The sensor data from sensor group 414 includes image data from camera C 410.

In another example, the spatial relationship module 402 detects that camera D 412 is located closer to or further from display 204 based on sensor data from sensor group 408 and sensor data from sensor group 416. In another example, the spatial relationship module 402 detects that the orientation between camera D 412 and display 204 has changed. As such, the spatial relationship module 402 detects linear displacement and/or rotational displacement. The sensor data from sensor group 416 includes image data from camera D 412. The sensor data from sensor group 408 includes IMU data from IMU C 228.

The spatial relationship module 402 starts to operate at runtime using the factory calibration data 222 as a starting point. The spatial relationship module 402 updates the spatial location relationship between the sensor groups (e.g., sensor group 306, sensor group 308, and sensor group 408, camera D 412, sensor group 416) based on the dynamic IMU data/image data from each IMU (e.g., IMU A 214, IMU B 226, IMU C 228) and/or cameras (e.g., camera A 212, camera B 224, camera C 410, camera D 412).

The bending estimate module 404 updates the spatial relation for non-instrumented components (e.g., actuator 418, display 204, temporarily disabled sensor groups). For example, the bending estimate module 404 estimates a mechanical deformation (e.g., bending of the display device 106) based on the changes in spatial relationship between the components based on the IMU data/image data.

In one example, the bending estimate module 404 estimates a magnitude and a direction of the bending of an eyewear frame of the display device 106: temples of the eyewear frame are spread outwards, the distance between the cameras has decreased, the orientation of the cameras are misaligned by x degrees, the relative location between the display 204 and the actuator 418 has changed, etc. . . . . Since an IMU has a higher sampling rate and is rigidly mounted to the non-instrumented component, the bending estimate module 404 can use IMU/camera sensor data to measure high dynamic mechanical deformation and predict spatial changes between image frames. The bending estimate module 404 can predict/estimate frame bending before camera frames are processed. Advantages of such bending prediction include: more accurate warping of search ranges, more robust measurement tracking, a system state that is closer to a true state resulting in smaller linearization errors and smaller corrections. Other advantages include faster processing (e.g., smaller search ranges, less estimator/optimizer iterations).

Once the spatial relationship module 402 and the bending estimate module 404 determine the updated spatial relationship between the sensor groups, the mitigation module 406 compares the updated spatial relationship between the sensor groups to a desired spatial relationship (based on the factory calibration data 222). The mitigation module 406 uses the discrepancies between the updated spatial relationship and the factory calibrated relationship to compute the amount of bending or misalignment that has occurred. The mitigation module 406 mitigates this bending or misalignment by adjusting the display or other components of the HMD in real-time. For example, if the display is misaligned, the mitigation module 406 can adjust the display image to compensate for the misalignment, so that the user perceives a correctly aligned virtual environment.

In one example, the mitigation module 406 uses the spatial relation data from spatial relationship module 402 and bending estimate module 404 to perform operations to mitigate spatial changes between sensor groups due to mechanical deformation of the display device 106. Examples of mitigation functionalities include: (1) depth correction, (2) render correction, and (3) feature prediction and feature tracking. Depth correction relates to adjusting detected depth in an image based on the relative spatial changes between cameras of sensor groups. Render correction relates to adjusting a rendering of a virtual object based on the relative spatial changes between the sensor groups. Feature prediction relates to using the spatial relation data and information from previous frames to predict the location of an object or feature in the current frame. Feature tracking relates to using the spatial relation data and image data to identify and follow a particular object or feature through a sequence of images or video frames. In one example, the mitigation module 406 is able to predict and track locations of sparse features based on the updated bending information and the IMU data.

In one example, the mitigation module 406 uses the deformation estimate to correct bending that results in a pitch, roll or yaw deviation of the display device 106. The mitigation module 406 determines a rectified coordinate system based on the deformation estimate. In other examples, the mitigation module 406 adjusts/re-align the image data from a camera based on the bending estimate. In other examples, the mitigation module 406 determines whether to rectify a bending that results in a rotation deviation (e.g., yaw/pitch-roll offset) of the display device 106. The mitigation module 406 minimizes any deformation based on the bending estimates provided by the bending estimate module 404. For example, the mitigation module 406 is able to minimize yaw bias between the VIO depth and the stereo-depth algorithm results by correcting the yaw estimation. The corrected configuration is then communicated to the AR application 210 for display content based the corrected configuration.

To reduce computational complexity, spatial relations can be dynamically selected when to be estimated. For example, the proximity sensor 230 detects the user is wearing the display device 106 to determine whether spatial relations between the components have changed. The dynamic bending estimation module 216 thus operates in response to detecting the user wearing the display device 106. Thus, the computational workload can be reduced to save power, while maintaining high quality and accuracy of the AR experience.

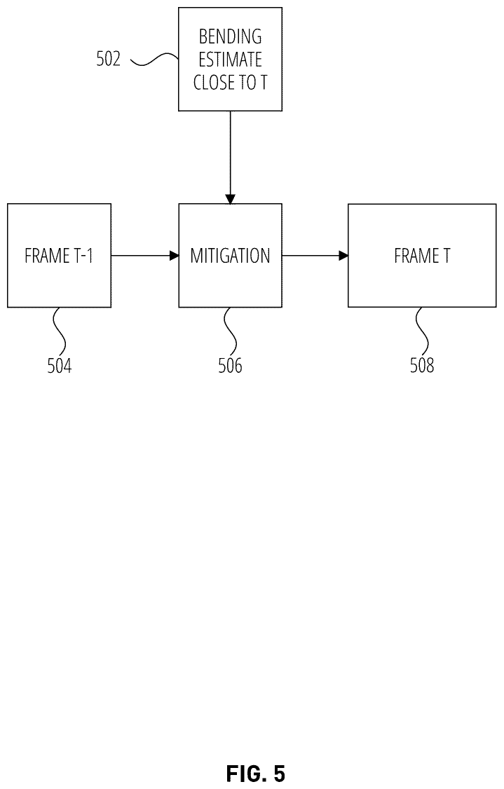

FIG. 5 is a block diagram illustrating a corrected depth frame in accordance with one embodiment. Camera A 212 generates a frame t−1 504 at time t−1. The dynamic bending estimation module 216 determines a bending estimate (e.g., bending estimate close to T 502) based on IMU data between the time when the camera generated the frame t−1 504 and the time when the camera generates a subsequent frame (e.g., frame t 508 at time t). The mitigation module 406 applies a correction at 506 prior to processing the frame t 508.

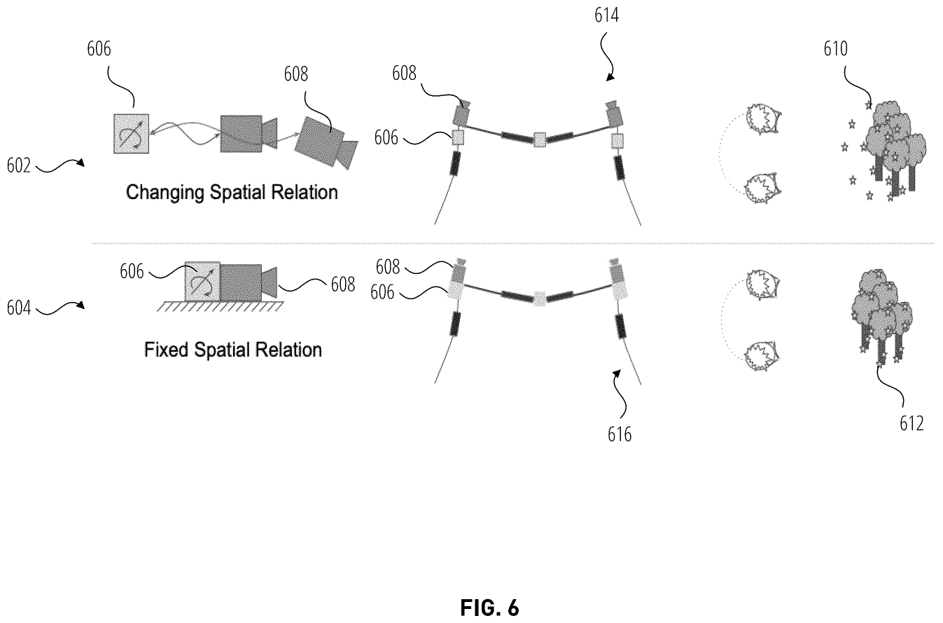

FIG. 6 illustrates rigid and non-rigid component coupling in accordance with one example embodiment. The non-rigid setting 602 illustrates an IMU 606 being flexibly coupled to camera 608. As such, the spatial relationship between the IMU 606 and the camera 608 can change as a result of a physical deformation of the display device 106 as a result of the user wearing the display device 106 as illustrated in arrangement 614. The physical deformation results in a misalignment between the IMU 606 and the camera 608 and results in inaccurate/offset sensor measurement 610.

The rigid setting 604 illustrates the IMU 606 being rigidly coupled to camera 608. As such, the spatial relationship between the IMU 606 and the camera 608 remains unchanged regardless of the physical deformation of the display device 106 as a result of the user wearing the display device 106 as illustrated in arrangement 616. The IMU data from IMU 606 can be used to predict the deformation and correct any misalignment between cameras for accurate sensor measurement 612.

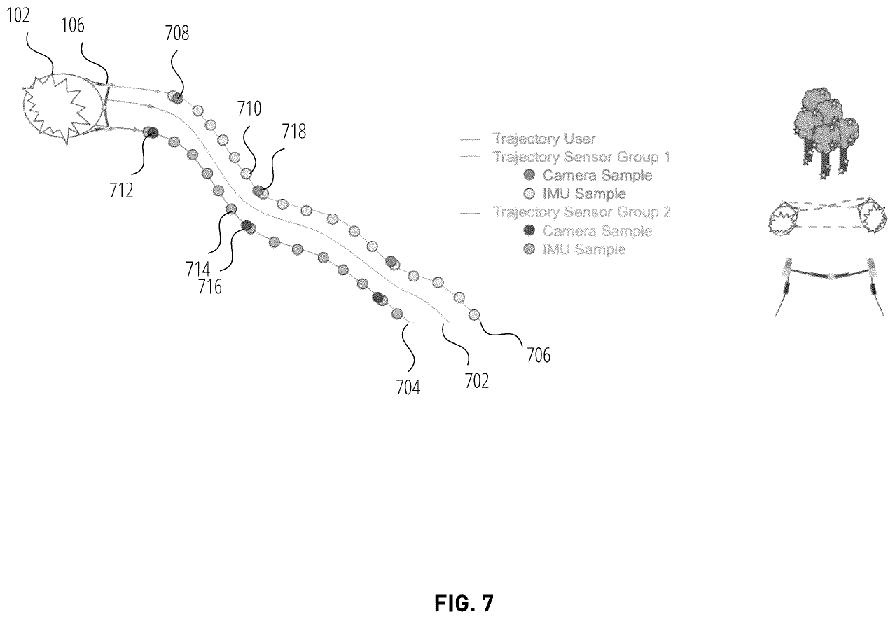

FIG. 7 illustrates an example user trajectory 702 of the display device 106 worn by the user 102 in accordance with one example embodiment. IMUs and Cameras are used to extract tracking information. The group 1 camera sample 708 is based on group 1 IMU and camera sensors. The group 2 camera sample 712 is based on group 2 IMU and camera sensors.

Since an IMU has a higher sampling rate and is rigidly mounted to a corresponding camera, its data is used to measure high dynamic mechanical deformation and predict spatial changes of cameras between image frames. For example, the sensor group 2 trajectory 704 includes several IMU samples (e.g., group 2 IMU sample 714) between group 2 camera sample 712 and group 2 camera sample 716. Similarly, the sensor group 1 trajectory 706 includes several IMU samples (e.g., group 1 IMU sample 710) between group 1 camera sample 708 and group 1 camera sample 718.

FIG. 8 is a flow diagram illustrating a method 800 for adjusting a frame in accordance with one example embodiment. Operations in the method 800 may be performed by the dynamic bending estimation module 216, using components (e.g., modules, engines) described above with respect to FIG. 4. Accordingly, the method 800 is described by way of example with reference to the spatial relationship module 402. However, it shall be appreciated that at least some of the operations of the method 800 may be deployed on various other hardware configurations or be performed by similar components residing elsewhere.

In block 802, the spatial relationship module 402 accesses factory calibration data of the display device 106. In block 804, the spatial relationship module 402 accesses (current) IMU data and/or image data of each sensor group. In block 806, the spatial relationship module 402 determines updated spatial relationships between each sensor group based on factory calibration data and IMU data/image data. In block 808, the bending estimate module 404 determines frame bending estimate based on updated spatial relationship. In block 810, the mitigation module 406 generates spatial change mitigation based on the frame bending estimate. In block 812, the mitigation module 406 adjusts a camera frame based on the spatial change mitigation. In another example, the mitigation module 406 adjusts a processing of the camera frame based on the functionalities described above with respect to the mitigation module 406 in FIG. 4.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

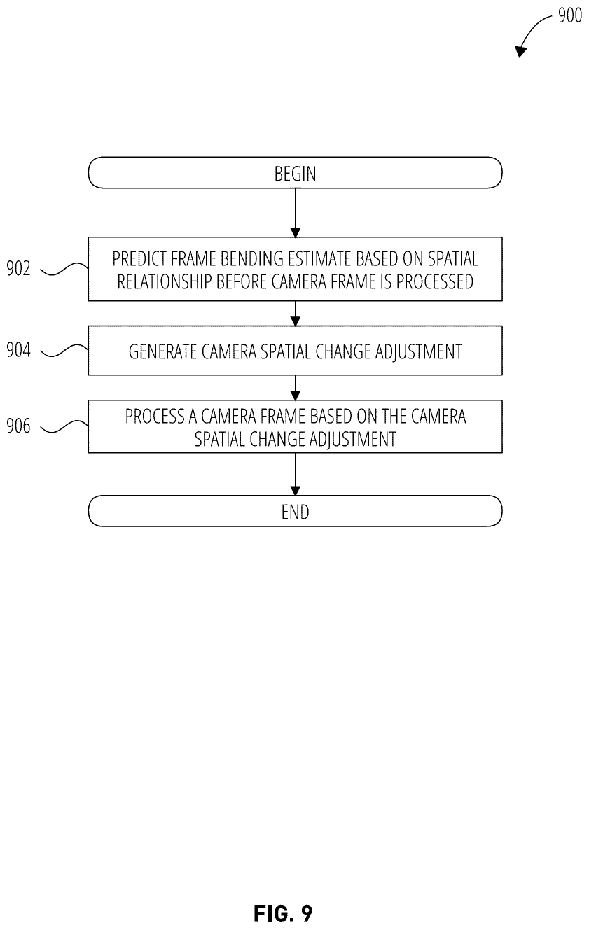

FIG. 9 is a flow diagram illustrating a method 900 for processing an image frame in accordance with one example embodiment. Operations in the method 900 may be performed by the dynamic bending estimation module 216, using components (e.g., modules, engines) described above with respect to FIG. 4. Accordingly, the method 900 is described by way of example with reference to the spatial relationship module 402. However, it shall be appreciated that at least some of the operations of the method 900 may be deployed on various other hardware configurations or be performed by similar components residing elsewhere.

In block 902, the bending estimate module 404 predicts frame bending estimate based on spatial relationship before camera frame is processed. In block 904, the mitigation module 406 generates camera spatial change adjustment. In block 906, the AR application 210 processes a camera frame based on the camera spatial change adjustment.

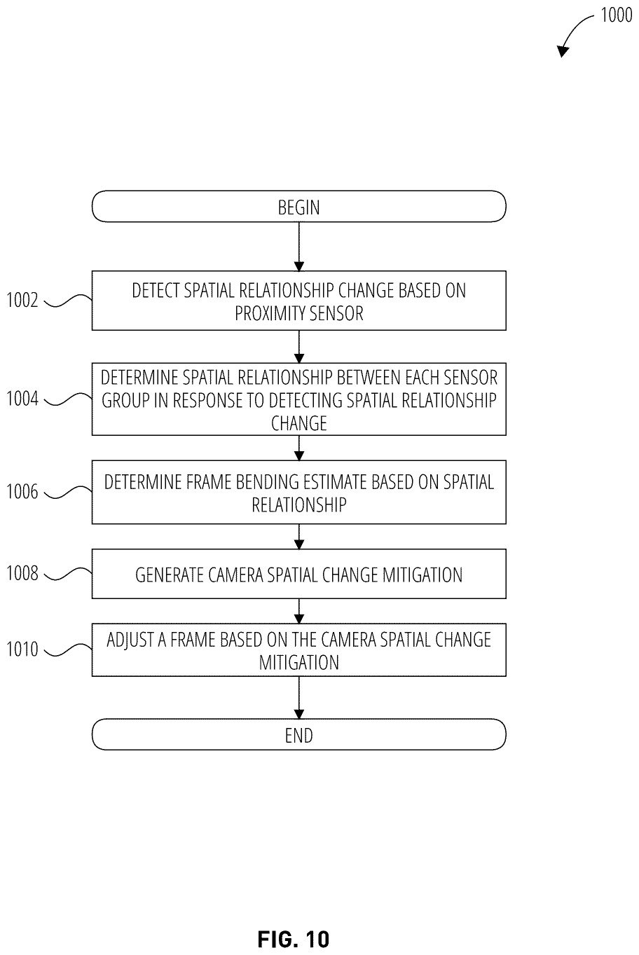

FIG. 10 is a flow diagram illustrating a method 1000 for detecting spatial changes based on a proximity sensor in accordance with one example embodiment. Operations in the method 1000 may be performed by the dynamic bending estimation module 216, using components (e.g., modules, engines) described above with respect to FIG. 4. Accordingly, the method 1000 is described by way of example with reference to the spatial relationship module 402. However, it shall be appreciated that at least some of the operations of the method 1000 may be deployed on various other hardware configurations or be performed by similar components residing elsewhere.

In block 1002, the spatial relationship module 402 detects spatial relationship change based on a trigger event as determined by the proximity sensor 230. In block 1004, the spatial relationship module 402 determines spatial relationship between each sensor group in response to detecting spatial relationship change. In block 1006, the bending estimate module 404 determines frame bending estimate based on spatial relationship. In block 1008, the mitigation module 406 generates camera spatial change mitigation. In block 1010, the AR application 210 adjusts an image frame based on the camera spatial change mitigation.

System with Head-Wearable Apparatus

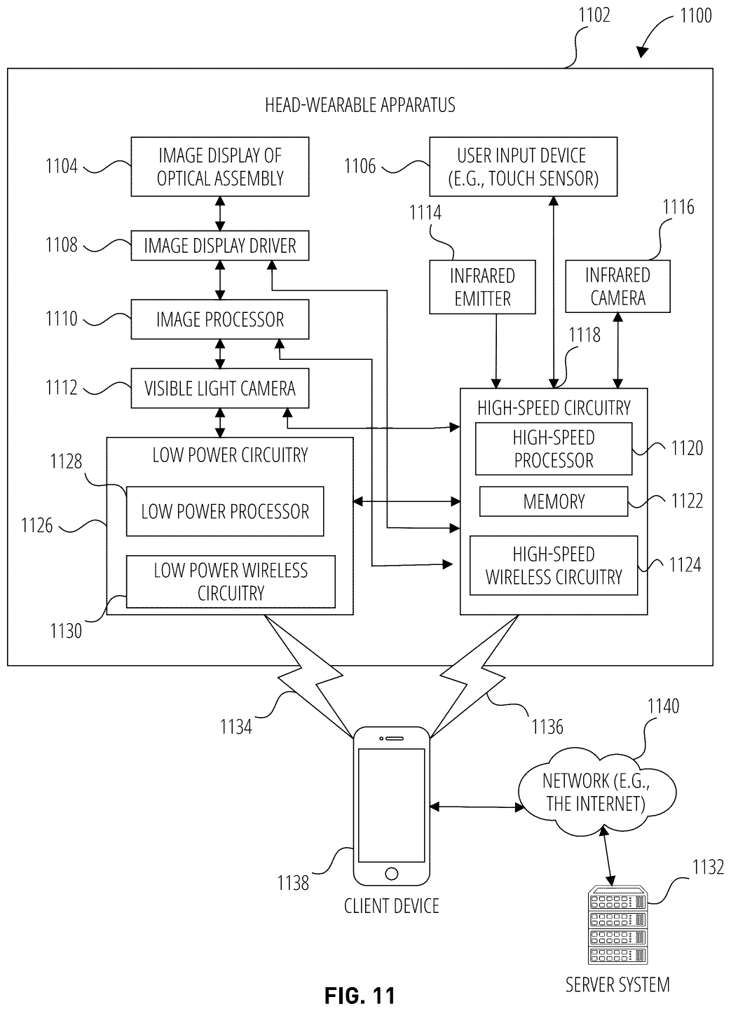

FIG. 11 illustrates a network environment 1100 in which the head-wearable apparatus 1102 can be implemented according to one example embodiment. FIG. 11 is a high-level functional block diagram of an example head-wearable apparatus 1102 communicatively coupled a mobile client device 1138 and a server system 1132 via various network 1140.

head-wearable apparatus 1102 includes a camera, such as at least one of visible light camera 1112, infrared emitter 1114 and infrared camera 1116. The client device 1138 can be capable of connecting with head-wearable apparatus 1102 using both a communication 1134 and a communication 1136. client device 1138 is connected to server system 1132 and network 1140. The network 1140 may include any combination of wired and wireless connections.

The head-wearable apparatus 1102 further includes two image displays of the image display of optical assembly 1104. The two include one associated with the left lateral side and one associated with the right lateral side of the head-wearable apparatus 1102. The head-wearable apparatus 1102 also includes image display driver 1108, image processor 1110, low-power low power circuitry 1126, and high-speed circuitry 1118. The image display of optical assembly 1104 are for presenting images and videos, including an image that can include a graphical user interface to a user of the head-wearable apparatus 1102.

The image display driver 1108 commands and controls the image display of the image display of optical assembly 1104. The image display driver 1108 may deliver image data directly to the image display of the image display of optical assembly 1104 for presentation or may have to convert the image data into a signal or data format suitable for delivery to the image display device. For example, the image data may be video data formatted according to compression formats, such as H. 264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (Exif) or the like.

As noted above, head-wearable apparatus 1102 includes a frame and stems (or temples) extending from a lateral side of the frame. The head-wearable apparatus 1102 further includes a user input device 1106 (e.g., touch sensor or push button) including an input surface on the head-wearable apparatus 1102. The user input device 1106 (e.g., touch sensor or push button) is to receive from the user an input selection to manipulate the graphical user interface of the presented image.

The components shown in FIG. 11 for the head-wearable apparatus 1102 are located on one or more circuit boards, for example a PCB or flexible PCB, in the rims or temples. Alternatively, or additionally, the depicted components can be located in the chunks, frames, hinges, or bridge of the head-wearable apparatus 1102. Left and right can include digital camera elements such as a complementary metal-oxide-semiconductor (CMOS) image sensor, charge coupled device, a camera lens, or any other respective visible or light capturing elements that may be used to capture data, including images of scenes with unknown objects.

The head-wearable apparatus 1102 includes a memory 1122 which stores instructions to perform a subset or all of the functions described herein. memory 1122 can also include storage device.

As shown in FIG. 11, high-speed circuitry 1118 includes high-speed processor 1120, memory 1122, and high-speed wireless circuitry 1124. In the example, the image display driver 1108 is coupled to the high-speed circuitry 1118 and operated by the high-speed processor 1120 in order to drive the left and right image displays of the image display of optical assembly 1104. high-speed processor 1120 may be any processor capable of managing high-speed communications and operation of any general computing system needed for head-wearable apparatus 1102. The high-speed processor 1120 includes processing resources needed for managing high-speed data transfers on communication 1136 to a wireless local area network (WLAN) using high-speed wireless circuitry 1124. In certain examples, the high-speed processor 1120 executes an operating system such as a LINUX operating system or other such operating system of the head-wearable apparatus 1102 and the operating system is stored in memory 1122 for execution. In addition to any other responsibilities, the high-speed processor 1120 executing a software architecture for the head-wearable apparatus 1102 is used to manage data transfers with high-speed wireless circuitry 1124. In certain examples, high-speed wireless circuitry 1124 is configured to implement Institute of Electrical and Electronic Engineers (IEEE) 802.11 communication standards, also referred to herein as Wi-Fi. In other examples, other high-speed communications standards may be implemented by high-speed wireless circuitry 1124.

The low power wireless circuitry 1130 and the high-speed wireless circuitry 1124 of the head-wearable apparatus 1102 can include short range transceivers (Bluetooth™) and wireless wide, local, or wide area network transceivers (e.g., cellular or Wi-Fi). The client device 1138, including the transceivers communicating via the communication 1134 and communication 1136, may be implemented using details of the architecture of the head-wearable apparatus 1102, as can other elements of network 1140.

The memory 1122 includes any storage device capable of storing various data and applications, including, among other things, camera data generated by the left and right, infrared camera 1116, and the image processor 1110, as well as images generated for display by the image display driver 1108 on the image displays of the image display of optical assembly 1104. While memory 1122 is shown as integrated with high-speed circuitry 1118, in other examples, memory 1122 may be an independent standalone element of the head-wearable apparatus 1102. In certain such examples, electrical routing lines may provide a connection through a chip that includes the high-speed processor 1120 from the image processor 1110 or low power processor 1128 to the memory 1122. In other examples, the high-speed processor 1120 may manage addressing of memory 1122 such that the low power processor 1128 will boot the high-speed processor 1120 any time that a read or write operation involving memory 1122 is needed.

As shown in FIG. 11, the low power processor 1128 or high-speed processor 1120 of the head-wearable apparatus 1102 can be coupled to the camera (visible light camera 1112; infrared emitter 1114, or infrared camera 1116), the image display driver 1108, the user input device 1106 (e.g., touch sensor or push button), and the memory 1122.

The head-wearable apparatus 1102 is connected with a host computer. For example, the head-wearable apparatus 1102 is paired with the client device 1138 via the communication 1136 or connected to the server system 1132 via the network 1140. server system 1132 may be one or more computing devices as part of a service or network computing system, for example, that include a processor, a memory, and network communication interface to communicate over the network 1140 with the client device 1138 and head-wearable apparatus 1102.

The client device 1138 includes a processor and a network communication interface coupled to the processor. The network communication interface allows for communication over the network 1140, communication 1134 or communication 1136. client device 1138 can further store at least portions of the instructions for generating a binaural audio content in the client device 1138's memory to implement the functionality described herein.

Output components of the head-wearable apparatus 1102 include visual components, such as a display such as a liquid crystal display (LCD), a plasma display panel (PDP), a light emitting diode (LED) display, a projector, or a waveguide. The image displays of the optical assembly are driven by the image display driver 1108. The output components of the head-wearable apparatus 1102 further include acoustic components (e.g., speakers), haptic components (e.g., a vibratory motor), other signal generators, and so forth. The input components of the head-wearable apparatus 1102, the client device 1138, and server system 1132, such as the user input device 1106, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 1102 may optionally include additional peripheral device elements. Such peripheral device elements may include biometric sensors, additional sensors, or display elements integrated with head-wearable apparatus 1102. For example, peripheral device elements may include any I/O components including output components, motion components, position components, or any other such elements described herein.

For example, the biometric components include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over and communication 1136 from the client device 1138 via the low power wireless circuitry 1130 or high-speed wireless circuitry 1124.

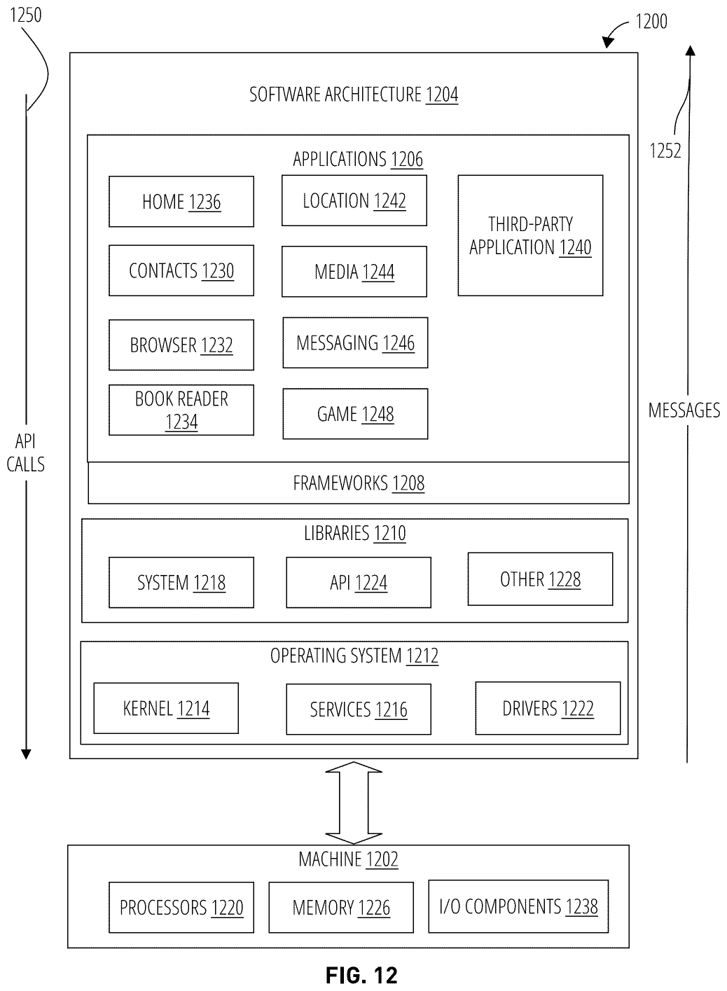

FIG. 12 is a block diagram 1200 illustrating a software architecture 1204, which can be installed on any one or more of the devices described herein. The software architecture 1204 is supported by hardware such as a machine 1202 that includes Processors 1220, memory 1226, and I/O Components 1238. In this example, the software architecture 1204 can be conceptualized as a stack of layers, where each layer provides a particular functionality. The software architecture 1204 includes layers such as an operating system 1212, libraries 1210, frameworks 1208, and applications 1206. Operationally, the applications 1206 invoke API calls 1250 through the software stack and receive messages 1252 in response to the API calls 1250.

The operating system 1212 manages hardware resources and provides common services. The operating system 1212 includes, for example, a kernel 1214, services 1216, and drivers 1222. The kernel 1214 acts as an abstraction layer between the hardware and the other software layers. For example, the kernel 1214 provides memory management, Processor management (e.g., scheduling), Component management, networking, and security settings, among other functionality. The services 1216 can provide other common services for the other software layers. The drivers 1222 are responsible for controlling or interfacing with the underlying hardware. For instance, the drivers 1222 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1210 provide a low-level common infrastructure used by the applications 1206. The libraries 1210 can include system libraries 1218 (e.g., C standard library) that provide functions such as memory allocation functions, string manipulation functions, mathematic functions, and the like. In addition, the libraries 1210 can include API libraries 1224 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1210 can also include a wide variety of other libraries 1228 to provide many other APIs to the applications 1206.

The frameworks 1208 provide a high-level common infrastructure that is used by the applications 1206. For example, the frameworks 1208 provide various graphical user interface (GUI) functions, high-level resource management, and high-level location services. The frameworks 1208 can provide a broad spectrum of other APIs that can be used by the applications 1206, some of which may be specific to a particular operating system or platform.

In an example embodiment, the applications 1206 may include a home application 1236, a contacts application 1230, a browser application 1232, a book reader application 1234, a location application 1242, a media application 1244, a messaging application 1246, a game application 1248, and a broad assortment of other applications such as a third-party application 1240. The applications 1206 are programs that execute functions defined in the programs. Various programming languages can be employed to create one or more of the applications 1206, structured in a variety of manners, such as object-oriented programming languages (e.g., Objective-C, Java, or C++) or procedural programming languages (e.g., C or assembly language). In a specific example, the third-party application 1240 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1240 can invoke the API calls 1250 provided by the operating system 1212 to facilitate functionality described herein.

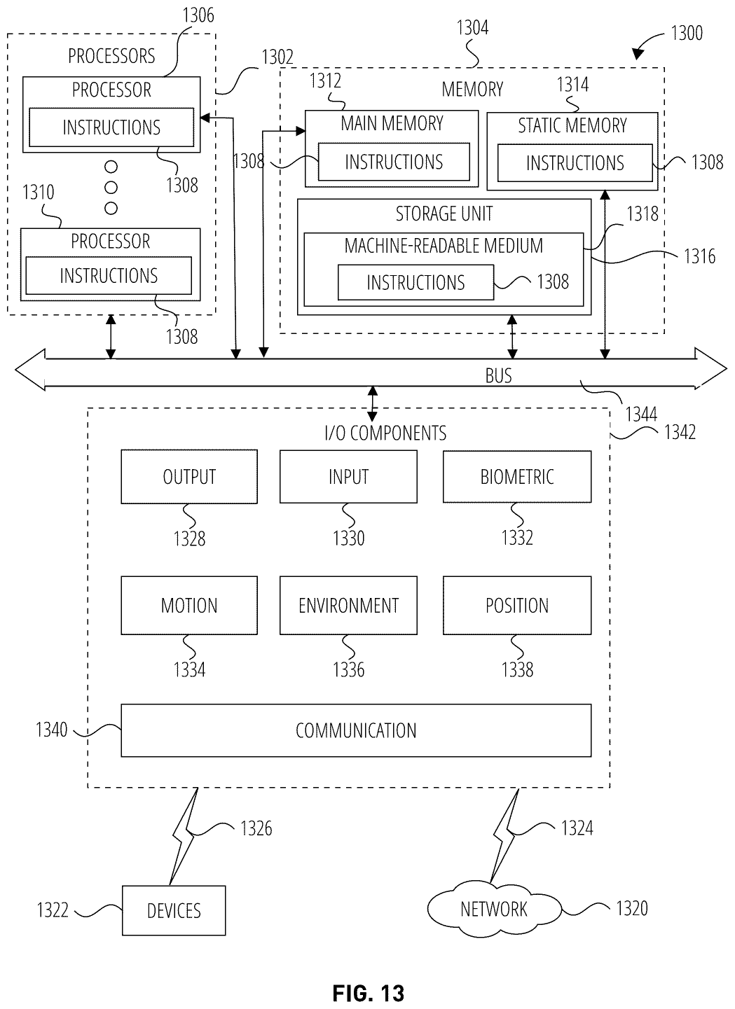

FIG. 13 is a diagrammatic representation of the machine 1300 within which instructions 1308 (e.g., software, a program, an application, an applet, an app, or other executable code) for causing the machine 1300 to perform any one or more of the methodologies discussed herein may be executed. For example, the instructions 1308 may cause the machine 1300 to execute any one or more of the methods described herein. The instructions 1308 transform the general, non-programmed machine 1300 into a particular machine 1300 programmed to carry out the described and illustrated functions in the manner described. The machine 1300 may operate as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1308, sequentially or otherwise, that specify actions to be taken by the machine 1300. Further, while only a single machine 1300 is illustrated, the term “machine” shall also be taken to include a collection of machines that individually or jointly execute the instructions 1308 to perform any one or more of the methodologies discussed herein.

The machine 1300 may include Processors 1302, memory 1304, and I/O Components 1342, which may be configured to communicate with each other via a bus 1344. In an example embodiment, the Processors 1302 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a Processor 1306 and a Processor 1310 that execute the instructions 1308. The term “Processor” is intended to include multi-core Processors that may comprise two or more independent Processors (sometimes referred to as “cores”) that may execute instructions contemporaneously. Although FIG. 13 shows multiple Processors 1302, the machine 1300 may include a single Processor with a single core, a single Processor with multiple cores (e.g., a multi-core Processor), multiple Processors with a single core, multiple Processors with multiples cores, or any combination thereof.

The memory 1304 includes a main memory 1312, a static memory 1314, and a storage unit 1316, both accessible to the Processors 1302 via the bus 1344. The main memory 1304, the static memory 1314, and storage unit 1316 store the instructions 1308 embodying any one or more of the methodologies or functions described herein. The instructions 1308 may also reside, completely or partially, within the main memory 1312, within the static memory 1314, within machine-readable medium 1318 within the storage unit 1316, within at least one of the Processors 1302 (e.g., within the Processor's cache memory), or any suitable combination thereof, during execution thereof by the machine 1300.

The I/O Components 1342 may include a wide variety of Components to receive input, provide output, produce output, transmit information, exchange information, capture measurements, and so on. The specific I/O Components 1342 that are included in a particular machine will depend on the type of machine. For example, portable machines such as mobile phones may include a touch input device or other such input mechanisms, while a headless server machine will likely not include such a touch input device. It will be appreciated that the I/O Components 1342 may include many other Components that are not shown in FIG. 13. In various example embodiments, the I/O Components 1342 may include output Components 1328 and input Components 1330. The output Components 1328 may include visual Components (e.g., a display such as a plasma display panel (PDP), a light emitting diode (LED) display, a liquid crystal display (LCD), a projector, or a cathode ray tube (CRT)), acoustic Components (e.g., speakers), haptic Components (e.g., a vibratory motor, resistance mechanisms), other signal generators, and so forth. The input Components 1330 may include alphanumeric input Components (e.g., a keyboard, a touch screen configured to receive alphanumeric input, a photo-optical keyboard, or other alphanumeric input Components), point-based input Components (e.g., a mouse, a touchpad, a trackball, a joystick, a motion sensor, or another pointing instrument), tactile input Components (e.g., a physical button, a touch screen that provides location and/or force of touches or touch gestures, or other tactile input Components), audio input Components (e.g., a microphone), and the like.

In further example embodiments, the I/O Components 1342 may include biometric Components 1332, motion Components 1334, environmental Components 1336, or position Components 1338, among a wide array of other Components. For example, the biometric Components 1332 include Components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion Components 1334 include acceleration sensor Components (e.g., accelerometer), gravitation sensor Components, rotation sensor Components (e.g., gyroscope), and so forth. The environmental Components 1336 include, for example, illumination sensor Components (e.g., photometer), temperature sensor Components (e.g., one or more thermometers that detect ambient temperature), humidity sensor Components, pressure sensor Components (e.g., barometer), acoustic sensor Components (e.g., one or more microphones that detect background noise), proximity sensor Components (e.g., infrared sensors that detect nearby objects), gas sensors (e.g., gas detection sensors to detection concentrations of hazardous gases for safety or to measure pollutants in the atmosphere), or other Components that may provide indications, measurements, or signals corresponding to a surrounding physical environment. The position Components 1338 include location sensor Components (e.g., a GPS receiver Component), altitude sensor Components (e.g., altimeters or barometers that detect air pressure from which altitude may be derived), orientation sensor Components (e.g., magnetometers), and the like.

Communication may be implemented using a wide variety of technologies. The I/O Components 1342 further include communication Components 1340 operable to couple the machine 1300 to a network 1320 or devices 1322 via a coupling 1324 and a coupling 1326, respectively. For example, the communication Components 1340 may include a network interface Component or another suitable device to interface with the network 1320. In further examples, the communication Components 1340 may include wired communication Components, wireless communication Components, cellular communication Components, Near Field Communication (NFC) Components, Bluetooth® Components (e.g., Bluetooth® Low Energy), Wi-Fi® Components, and other communication Components to provide communication via other modalities. The devices 1322 may be another machine or any of a wide variety of peripheral devices (e.g., a peripheral device coupled via a USB).

Moreover, the communication Components 1340 may detect identifiers or include Components operable to detect identifiers. For example, the communication Components 1340 may include Radio Frequency Identification (RFID) tag reader Components, NFC smart tag detection Components, optical reader Components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection Components (e.g., microphones to identify tagged audio signals). In addition, a variety of information may be derived via the communication Components 1340, such as location via Internet Protocol (IP) geolocation, location via Wi-Fi® signal triangulation, location via detecting an NFC beacon signal that may indicate a particular location, and so forth.

The various memories (e.g., memory 1304, main memory 1312, static memory 1314, and/or memory of the Processors 1302) and/or storage unit 1316 may store one or more sets of instructions and data structures (e.g., software) embodying or used by any one or more of the methodologies or functions described herein. These instructions (e.g., the instructions 1308), when executed by Processors 1302, cause various operations to implement the disclosed embodiments.

The instructions 1308 may be transmitted or received over the network 1320, using a transmission medium, via a network interface device (e.g., a network interface Component included in the communication Components 1340) and using any one of a number of well-known transfer protocols (e.g., hypertext transfer protocol (HTTP)). Similarly, the instructions 1308 may be transmitted or received using a transmission medium via the coupling 1326 (e.g., a peer-to-peer coupling) to the devices 1322.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

### Examples

Example 1 is a method comprising: forming a plurality of sensor groups of an augmented reality (AR) display device, wherein one of the plurality of sensor groups comprises a combination of a camera, an IMU (inertial measurement unit), and a component, each being tightly coupled to each other, a spatial relationship between the camera, the IMU sensor, or the component being predefined; accessing sensor groups data from the plurality of sensor groups; estimating a spatial relationship between the plurality of sensor groups based on the sensor groups data; and displaying virtual content in a display of the AR display device based on the spatial relationship between the plurality of sensor groups.

In Example 2, the subject matter of Example 1 includes, accessing factory calibration data indicating a static or dynamic spatial relationship among the plurality of sensor groups, wherein the spatial relationship between each sensor group is predefined, wherein estimating the spatial relationship between the plurality of sensor groups is based on the factory calibration data.

In Example 3, the subject matter of Example 2 includes, wherein one of the plurality of sensor groups comprises one of the IMU sensor tightly coupled to the camera, the IMU sensor tightly coupled to the component, and the camera tightly coupled to the component, wherein the component comprises one of a display component, a projector, an illuminator, LIDAR component, or an actuator.

In Example 4, the subject matter of Example 3 includes, estimating the spatial relationship between a first sensor group and a second sensor group of the plurality of sensor groups based on the sensor groups data; and estimating a bending of the AR display device based on the spatial relationship between the first sensor group and the second sensor group.

In Example 5, the subject matter of Example 4 includes, wherein estimating the spatial relationship between the plurality of sensor groups is based on the factory calibration data and a combination of image data and IMU data from each sensor group.

In Example 6, the subject matter of Examples 1-5 includes, wherein estimating the spatial relationship between the plurality of sensor groups further comprises: fusing data from the plurality of sensor groups; and correcting one or more sensor data based on the fused data.

In Example 7, the subject matter of Examples 1-6 includes, capturing a first set of image frames from a set of cameras of the AR display device; accessing the IMU data between the first set of image frames and a second set of image frames, wherein the second set of image frames is generated after the first set of image frames; estimating a first spatial relationship between each camera of the set of cameras for the first set of image frames; estimating a second spatial relationship between each camera of the set of cameras for the second set of image frames with the IMU data; and processing the second set of image frames based on the first spatial relationship and the second spatial relationship.

In Example 8, the subject matter of Example 7 includes, wherein processing the second set of image frames comprises: adjusting a predicted location of the virtual content in the second set of image frames based on the second spatial relationship between each camera of the set of cameras for the second set of image frames.

In Example 9, the subject matter of Examples 1-8 includes, wherein the AR display device comprises a proximity sensor, wherein the method comprises: detecting a trigger event based on proximity data from the proximity sensor, wherein estimating the spatial relationship between the plurality of sensor groups is in response to detecting the trigger event.

In Example 10, the subject matter of Examples 1-9 includes, wherein the AR display device includes an eyewear frame.

Example 11 is a computing apparatus comprising: a processor; and a memory storing instructions that, when executed by the processor, configure the apparatus to perform operations comprising: forming a plurality of sensor groups of an augmented reality (AR) display device, wherein one of the plurality of sensor groups comprises a combination of a camera, an IMU (inertial measurement unit), and a component, each being tightly coupled to each other, a spatial relationship between the camera, the IMU sensor, or the component being predefined; accessing sensor groups data from the plurality of sensor groups; estimating a spatial relationship between the plurality of sensor groups based on the sensor groups data; and displaying virtual content in a display of the AR display device based on the spatial relationship between the plurality of sensor groups.

In Example 12, the subject matter of Example 11 includes, wherein the operations comprise: accessing factory calibration data indicating a static or dynamic spatial relationship among the plurality of sensor groups, wherein the spatial relationship between each sensor group is predefined, wherein estimating the spatial relationship between the plurality of sensor groups is based on the factory calibration data.

In Example 13, the subject matter of Example 12 includes, wherein one of the plurality of sensor groups comprises one of the IMU sensor tightly coupled to the camera, the IMU sensor tightly coupled to the component, and the camera tightly coupled to the component, wherein the component comprises one of a display component, a projector, an illuminator, LIDAR component, or an actuator.

In Example 14, the subject matter of Example 13 includes, wherein the operations comprise: estimating the spatial relationship between a first sensor group and a second sensor group of the plurality of sensor groups based on the sensor groups data; and estimating a bending of the AR display device based on the spatial relationship between the first sensor group and the second sensor group.

In Example 15, the subject matter of Example 14 includes, wherein estimating the spatial relationship between the plurality of sensor groups is based on the factory calibration data and a combination of image data and IMU data from each sensor group.

In Example 16, the subject matter of Examples 11-15 includes, wherein estimating the spatial relationship between the plurality of sensor groups further comprises: fusing data from the plurality of sensor groups; and correcting one or more sensor data based on the fused data.

In Example 17, the subject matter of Examples 11-16 includes, wherein the operations comprise: capturing a first set of image frames from a set of cameras of the AR display device; accessing the IMU data between the first set of image frames and a second set of image frames, wherein the second set of image frames is generated after the first set of image frames; estimating a first spatial relationship between each camera of the set of cameras for the first set of image frames; estimating a second spatial relationship between each camera of the set of cameras for the second set of image frames with the IMU data; and processing the second set of image frames based on the first spatial relationship and the second spatial relationship.

In Example 18, the subject matter of Example 17 includes, wherein processing the second set of image frames comprises: adjusting a predicted location of the virtual content in the second set of image frames based on the second spatial relationship between each camera of the set of cameras for the second set of image frames.

In Example 19, the subject matter of Examples 11-18 includes, wherein the AR display device comprises a proximity sensor, wherein the method comprises: detect a trigger event based on proximity data from the proximity sensor, wherein estimating the spatial relationship between the plurality of sensor groups is in response to detecting the trigger event.

Example 20 is a non-transitory computer-readable storage medium, the computer-readable storage medium including instructions that when executed by a computer, cause the computer to: forming a plurality of sensor groups of an augmented reality (AR) display device, wherein one of the plurality of sensor groups comprises a combination of a camera, an IMU (inertial measurement unit), and a component, each being tightly coupled to each other, a spatial relationship between the camera, the IMU sensor, or the component being predefined; accessing sensor groups data from the plurality of sensor groups; estimating a spatial relationship between the plurality of sensor groups based on the sensor groups data; and displaying virtual content in a display of the AR display device based on the spatial relationship between the plurality of sensor groups.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method comprising:
forming a plurality of sensor groups of an augmented reality (AR) display device, wherein one of the plurality of sensor groups comprises a combination of a camera, an IMU (inertial measurement unit), and a component, each being tightly coupled to each other, a spatial relationship between the camera, the IMU sensor, or the component being predefined;
accessing sensor groups data from the plurality of sensor groups;
estimating a spatial relationship between the plurality of sensor groups based on the sensor groups data; and
displaying virtual content in a display of the AR display device based on the spatial relationship between the plurality of sensor groups.

2. The method of claim 1, further comprising:
accessing factory calibration data indicating a static or dynamic spatial relationship among the plurality of sensor groups, wherein the spatial relationship between each sensor group is predefined,
wherein estimating the spatial relationship between the plurality of sensor groups is based on the factory calibration data.

3. The method of claim 2, further comprising:
wherein one of the plurality of sensor groups comprises one of the IMU sensor tightly coupled to the camera, the IMU sensor tightly coupled to the component, and the camera tightly coupled to the component,
wherein the component comprises one of a display component, a projector, an illuminator, LIDAR component, or an actuator.

4. The method of claim 3, further comprising:
estimating the spatial relationship between a first sensor group and a second sensor group of the plurality of sensor groups based on the sensor groups data; and
estimating a bending of the AR display device based on the spatial relationship between the first sensor group and the second sensor group.

5. The method of claim 4, wherein estimating the spatial relationship between the plurality of sensor groups is based on the factory calibration data and a combination of image data and IMU data from each sensor group.

6. The method of claim 1, wherein estimating the spatial relationship between the plurality of sensor groups further comprises:
fusing data from the plurality of sensor groups; and
correcting one or more sensor data based on the fused data.

7. The method of claim 1, further comprising:
capturing a first set of image frames from a set of cameras of the AR display device;
accessing the IMU data between the first set of image frames and a second set of image frames, wherein the second set of image frames is generated after the first set of image frames;
estimating a first spatial relationship between each camera of the set of cameras for the first set of image frames;
estimating a second spatial relationship between each camera of the set of cameras for the second set of image frames with the IMU data; and
processing the second set of image frames based on the first spatial relationship and the second spatial relationship.

8. The method of claim 7, wherein processing the second set of image frames comprises:
adjusting a predicted location of the virtual content in the second set of image frames based on the second spatial relationship between each camera of the set of cameras for the second set of image frames.

9. The method of claim 1, wherein the AR display device comprises a proximity sensor,
wherein the method comprises: detecting a trigger event based on proximity data from the proximity sensor,
wherein estimating the spatial relationship between the plurality of sensor groups is in response to detecting the trigger event.

10. The method of claim 1, wherein the AR display device includes an eyewear frame.

11. A computing apparatus comprising:
a processor; and
a memory storing instructions that, when executed by the processor, configure the apparatus to perform operations comprising:
forming a plurality of sensor groups of an augmented reality (AR) display device,
wherein one of the plurality of sensor groups comprises a combination of a camera, an IMU (inertial measurement unit), and a component, each being tightly coupled to each other, a spatial relationship between the camera, the IMU sensor, or the component being predefined;
accessing sensor groups data from the plurality of sensor groups;
estimating a spatial relationship between the plurality of sensor groups based on the sensor groups data; and
displaying virtual content in a display of the AR display device based on the spatial relationship between the plurality of sensor groups.

12. The computing apparatus of claim 11, wherein the operations comprise:
accessing factory calibration data indicating a static or dynamic spatial relationship among the plurality of sensor groups, wherein the spatial relationship between each sensor group is predefined,
wherein estimating the spatial relationship between the plurality of sensor groups is based on the factory calibration data.

13. The computing apparatus of claim 12, wherein one of the plurality of sensor groups comprises one of the IMU sensor tightly coupled to the camera, the IMU sensor tightly coupled to the component, and the camera tightly coupled to the component,
wherein the component comprises one of a display component, a projector, an illuminator, LIDAR component, or an actuator.

14. The computing apparatus of claim 13, wherein the operations comprise:
estimating the spatial relationship between a first sensor group and a second sensor group of the plurality of sensor groups based on the sensor groups data; and
estimating a bending of the AR display device based on the spatial relationship between the first sensor group and the second sensor group.

15. The computing apparatus of claim 14, wherein estimating the spatial relationship between the plurality of sensor groups is based on the factory calibration data and a combination of image data and IMU data from each sensor group.

16. The computing apparatus of claim 11, wherein estimating the spatial relationship between the plurality of sensor groups further comprises:
fusing data from the plurality of sensor groups; and
correcting one or more sensor data based on the fused data.

17. The computing apparatus of claim 11, wherein the operations comprise:
capturing a first set of image frames from a set of cameras of the AR display device;
accessing the IMU data between the first set of image frames and a second set of image frames, wherein the second set of image frames is generated after the first set of image frames;
estimating a first spatial relationship between each camera of the set of cameras for the first set of image frames;
estimating a second spatial relationship between each camera of the set of cameras for the second set of image frames with the IMU data; and
processing the second set of image frames based on the first spatial relationship and the second spatial relationship.

18. The computing apparatus of claim 17, wherein processing the second set of image frames comprises:
adjusting a predicted location of the virtual content in the second set of image frames based on the second spatial relationship between each camera of the set of cameras for the second set of image frames.

19. The computing apparatus of claim 11, wherein the AR display device comprises a proximity sensor,
wherein the method comprises: detect a trigger event based on proximity data from the proximity sensor,
wherein estimating the spatial relationship between the plurality of sensor groups is in response to detecting the trigger event.

20. A non-transitory computer-readable storage medium, the computer-readable storage medium including instructions that when executed by a computer, cause the computer to:
forming a plurality of sensor groups of an augmented reality (AR) display device,
wherein one of the plurality of sensor groups comprises a combination of a camera, an IMU (inertial measurement unit), and a component, each being tightly coupled to each other, a spatial relationship between the camera, the IMU sensor, or the component being predefined;
accessing sensor groups data from the plurality of sensor groups;
estimating a spatial relationship between the plurality of sensor groups based on the sensor groups data; and
displaying virtual content in a display of the AR display device based on the spatial relationship between the plurality of sensor groups.
